(19) United States
(12) Patent Application Publication
(10) Pub. No.: US 2008/0271575 A1
(43) Pub. Date: Nov. 6, 2008

(54) Socket connection device of adjustable tension value for preventing overlarge twisting force

(76) Inventor: Chih-Ching Hsieh, Taichung City (TW)

Correspondence Address: Chih-Ching Hsieh, 235 Chung-Ho, Box 8-24, Taipei, TW

(21) Appl. No.: 11/799,481

(22) Filed: May 2, 2007

(51) Int. Cl. B25B 13/06; F16D 3/00

(52) U.S. Cl. 81/121.1; 464/61.1

(57) ABSTRACT

A socket connection device of adjustable tension value for preventing an overlarge twisting force, comprises a seat having an approximate round cylinder; the seat having a receiving space; one end of the seat being an engaging portion; another end of the seat being a polygonal hole section; the control section including a base, an adjusting block, an axial rod, an elastic unit and a buckle block; the base serving for positioning the axial rod; the axial rod of the control section for installing the adjusting block, elastic unit and buckle block; and a head being formed as a long rod; one end of the head being a buckling end having a shape corresponding to that of the buckle block; an outer periphery of the head near the buckling end being formed with an annular groove; and another end of the head opposite to the buckling end is an engaging end.

### FIELD OF THE INVENTION

The present invention relates to hand tools, and particularly to a hand tool with a socket connection device of adjustable tension value for preventing an overlarge twisting force wherein the tension for stopping the spanner from the operation of a screw device is adjustable so as to provide a safety operation.

### BACKGROUND OF THE INVENTION

A socket is used to drive a screw unit so as to extend the operation range of the tool. One end of the socket is connected to a driving tool, such as a spanner or a dynamic tool, and another end of the socket is connected to a screw.

However in some applications, a connecting device is further added to the socket and then the connecting device is used to be connected to a screw device.

In one prior art, the socket is extendable and the upper end and lower end of the socket are used to lock another object. If the lower end of the socket is rotated, the elastic unit is driven so as to change the set tension value for stopping the socket from the operation of the screw device so as not to destroy the screw device.

In this prior art, the lower end of the socket has an engaging hole for being connected to a driven unit, such as a spanner or a dynamic tool. However in operating the socket for driving the screw device, the lower end of the socket is still possible to rotate with respect to the upper end of the socket and thus the set value of the tension is possibly changed.

Moreover, in adjustment of the set tension value, rotation of the lower end of the socket will cause the elastic unit to deform and for a long time, the socket is useless.

### SUMMARY OF THE INVENTION

Accordingly, the primary object of the present invention is to provide a socket connection device of adjustable tension value for preventing an overlarge twisting force wherein the tension for stopping the spanner from the operation of a screw device is adjustable so as to provide a safety operation.

To achieve above objects, the present invention provides a socket connection device of adjustable tension value for preventing an overlarge twisting force, comprising: a seat having an approximate round cylinder; the seat having a receiving space which penetrates through an upper and a lower ends of the seat; one end of the seat being an engaging portion; another end of the seat being a polygonal hole section; the control section including a base, an adjusting block, an axial rod, an elastic unit and a buckle block; the base serving for positioning the axial rod; the axial rod of the control section for installing the adjusting block, elastic unit and buckle block; two ends of the elastic unit resisting against the adjusting block and the buckle block; the buckle block being received in the hole section of the receiving space; an outer side of the buckle block being corresponding to an inner side of the hole section so that the buckle block will not rotate with respect to the receiving space; and a head being formed as a long rod; one end of the head being a buckling end having a shape corresponding to that of the buckle block; an outer periphery of the head near the buckling end being formed with an annular groove; and another end of the head opposite to the buckling end is an engaging end.

A connecting groove is formed at an outer side of the seat; the connecting groove is communicated to the receiving space; the connecting groove has a cambered shape; an adjusting ring encloses an outer side of the seat; a pin has one end fixed to an inner side of the adjusting ring; the pin passes through the connecting groove and then to be fixed to the adjusting block. Thus when the adjusting ring is rotated, the adjusting block will rotate therewith.

The various objects and advantages of the present invention will be more readily understood from the following detailed description when read in conjunction with the appended drawing.

### BRIEF DESCRIPTION OF THE DRAWINGS

FIG. 1 is a schematic perspective view of the socket connection device of adjustable tension value for preventing an overlarge twisting force of the present invention.

FIG. 2 is a perspective view of the socket connection device of adjustable tension value for preventing an overlarge twisting force of the present invention.

FIG. 3 is a schematic cross sectional view of the socket connection device of adjustable tension value for preventing an overlarge twisting force of the present invention.

FIG. 4 is a schematic view showing the application of the present invention.

FIG. 5 is a perspective view of the second embodiment of the present invention.

FIGS. 6 and 7 are schematic view showing the application of the present invention.

FIGS. 8 and 9 are schematic view showing the use of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

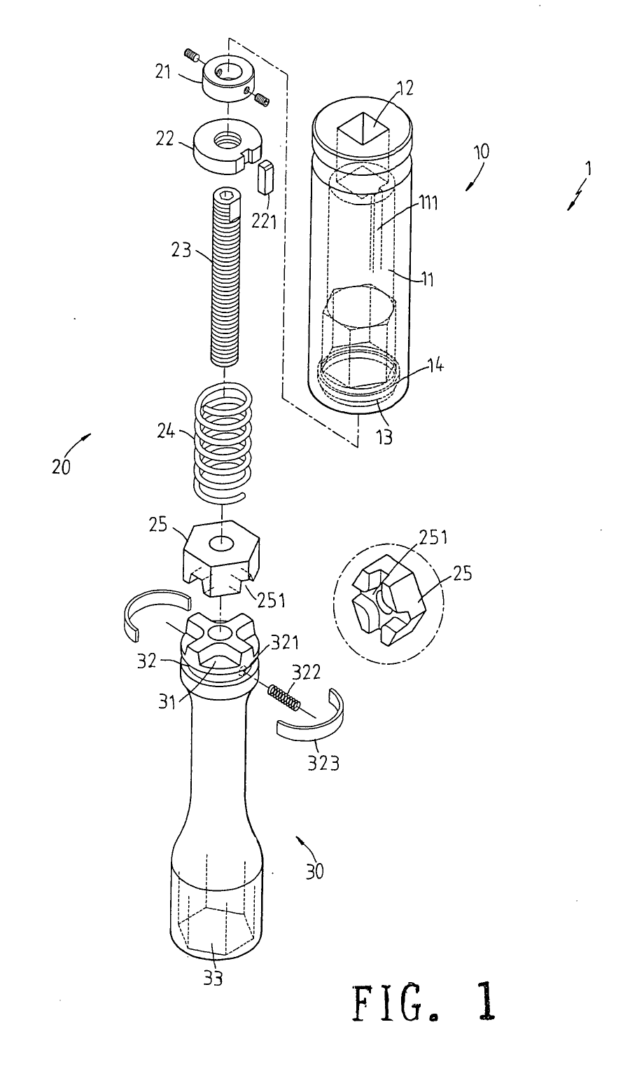

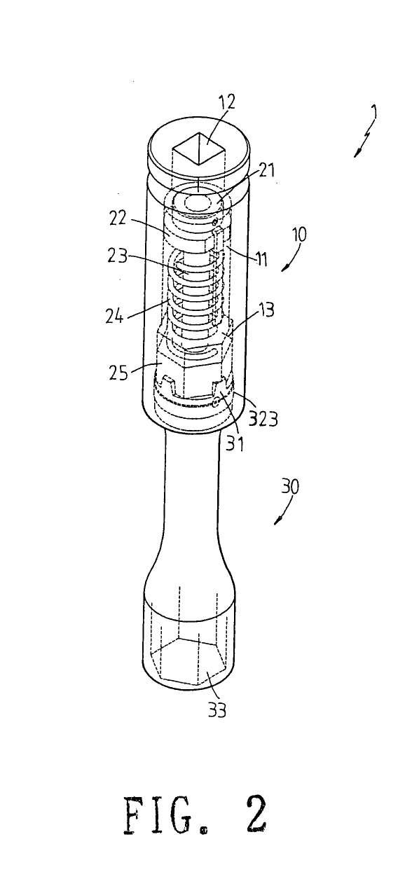

Referring to FIGS. 1 to 2, the tension socket connecting device of the present invention is illustrated. The present invention has the following elements.

A seat 10 has an approximate round cylinder. The seat 10 has a receiving space 11 which penetrates through an upper and a lower end of the seat 10. One side of the receiving space 11 has a key groove 111. One end of the seat 10 is an engaging portion 12 for engaging a spanner or a driving tool. Another end of the seat 10 is a polygonal hole section 13. An opening of the polygonal hole section 13 is an engaging groove 14.

The control section 20 includes a base 21, an adjusting block 22, an axial rod 23, an elastic unit 24 and a buckle block 25. The base 21 serves for positioning the axial rod 23. The base 21 may be integrally formed with the axial rod 23.

The axial rod 23 of the control section 20 serves for installing the adjusting block 22, elastic unit 24 and the buckle block 25. Two ends of the elastic unit 24 resist against the adjusting block 22 and the buckle block 25 so as to provide an elastic force to the buckle block 25. The adjusting block 22 has a key 221 which can be received in the key groove 111 of the receiving space 11 so as to position the adjusting block 22 without rotation.

The buckle block 25 is received in the polygonal hole section 13 of the receiving space 11. An outer side of the buckle block 25 is corresponding to an inner side of the polygonal hole section 13 so that the buckle block 25 will not rotate with respect to the receiving space 11. A lower side of the buckle block 25 facing to the opening of the polygonal hole section 13 is formed with a cruciform recessed area 251. The inner wall of the recessed area 251 is inclined, in that an upper side of the recessed area 251 has a smaller area and a lower side of the recessed area 251 has a larger area as illustrated in a partial view of FIG. 1.

A head 30 is formed as a long rod. One end of the head 30 is a buckling end 31 having a shape corresponding to that of the buckle block 25. An outer periphery of the head 30 near the buckling end 31 is formed with an annular groove 32. A through hole 321 is formed in the annular groove 32 for receiving an elastic body 322. Two C shape rings 323 are engaged in the annular groove 32 and also in the engaging groove 14 of the seat 10 so as to rotatably engage the head 30 to the seat 10.

Another end of the head 30 opposite to the buckling end 31 is an engaging end 33. In this embodiment, the engaging end 33 is a polygonal hole for receiving a screw means.

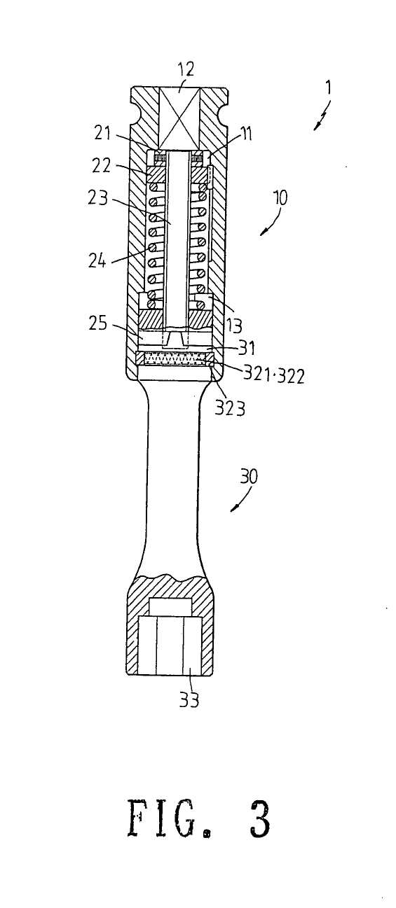

Referring to FIGS. 2 and 3, the assembly views of the present invention are illustrated. See FIG. 3, it is known that the base 21 of the control section 20 is fixed to the axial rod 23. The axial rod 23 serves to position the adjusting block 22, axial rod 23, elastic unit 24 and the buckle block 25. Thus one end of the elastic unit 24 is fixed by using the adjusting block 22 so as to resist against the buckle block 25 at another end of the elastic unit 24. The buckle block 25 is pushed by the elastic unit 24 so as to tightly engage to the engaging end 33 having a shape corresponding to the recessed area 251 of the buckle block 25. When the engaging end 33 of the head 30 is used to drive a screw means and then tension applied to the head 30 is over a predetermined value, the buckle block 25 will slide with respect to the engaging end 33 so as to achieve the object of stopping the operation. In manufacturing of the body 1 of the present invention, the value of the tension for stopping the operation can be predetermined so as to adjust the distance between the adjusting block 22 and the buckle block 25.

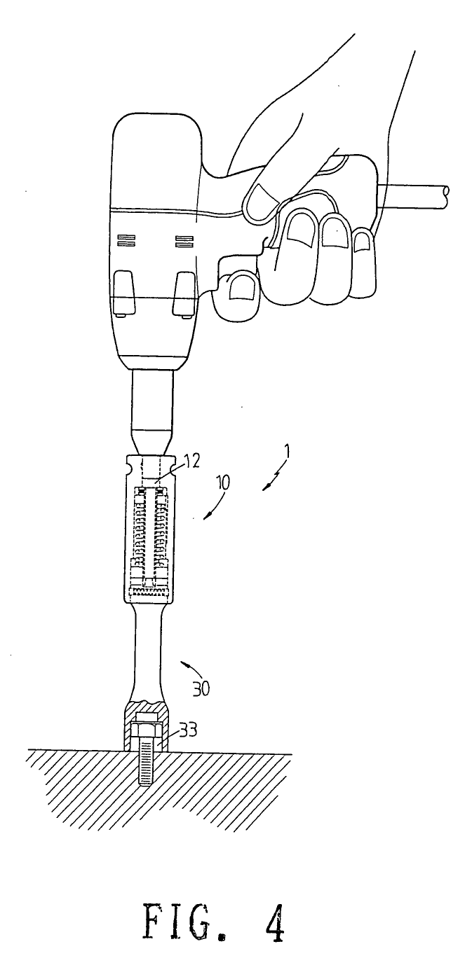

In use of the present invention, see FIG. 4, the engaging portion 12 of the seat 10 serves to assembly a spanner or a driving tool. Herein, an electromotive tool is used. The engaging end 33 of the head 30 is directly engaged with a screw unit so that the screw unit can be driven by the spanner of the present invention. Moreover, when the tension is too larger, it will stop so as to avoid the screw unit to be destroyed.

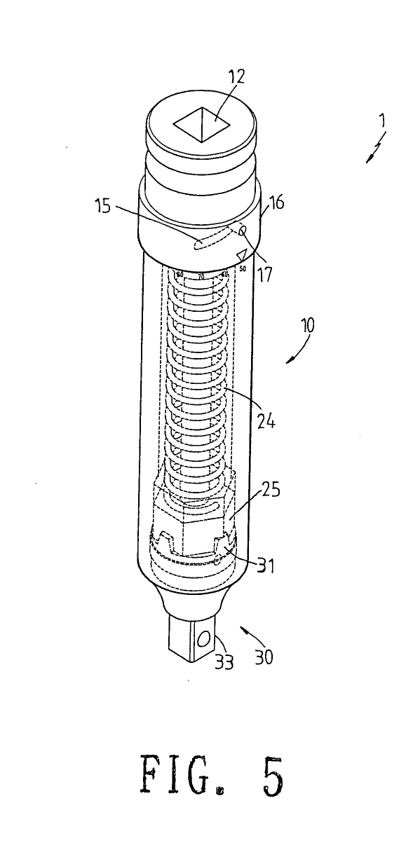

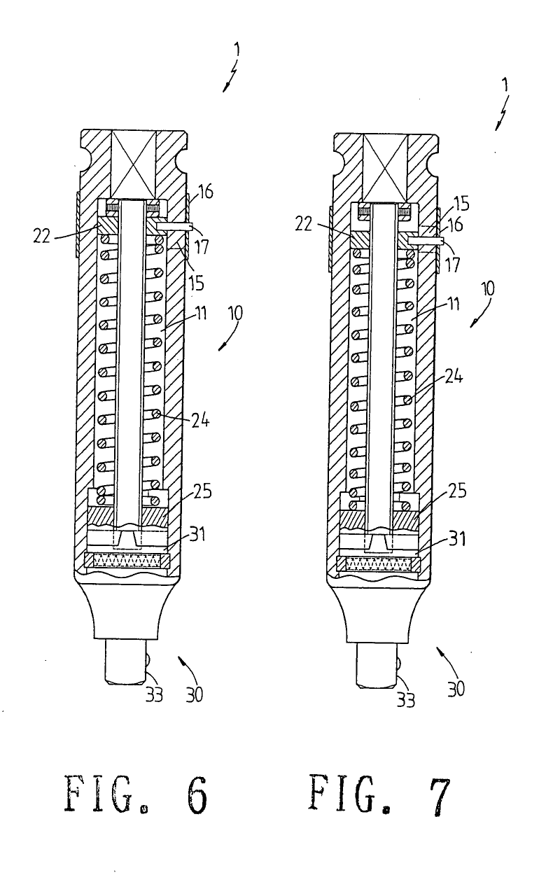

Referring to FIGS. 5 to 8, it is illustrated that a connecting groove 15 is formed at an outer side of the seat 10. The connecting groove 15 is communicated to the receiving space 11. The connecting groove 15 has a cambered shape. An adjusting ring 16 encloses an outer side of the seat 10. A pin 17 has one end fixed to an inner side of the adjusting ring 16. The pin passes through the connecting groove 15 and then to be fixed to the adjusting block 22. Thus when the adjusting ring 16 is rotated, the adjusting block 22 will rotate therewith. Thereby the user can drive the adjusting block 22 by moving the connecting groove 15.

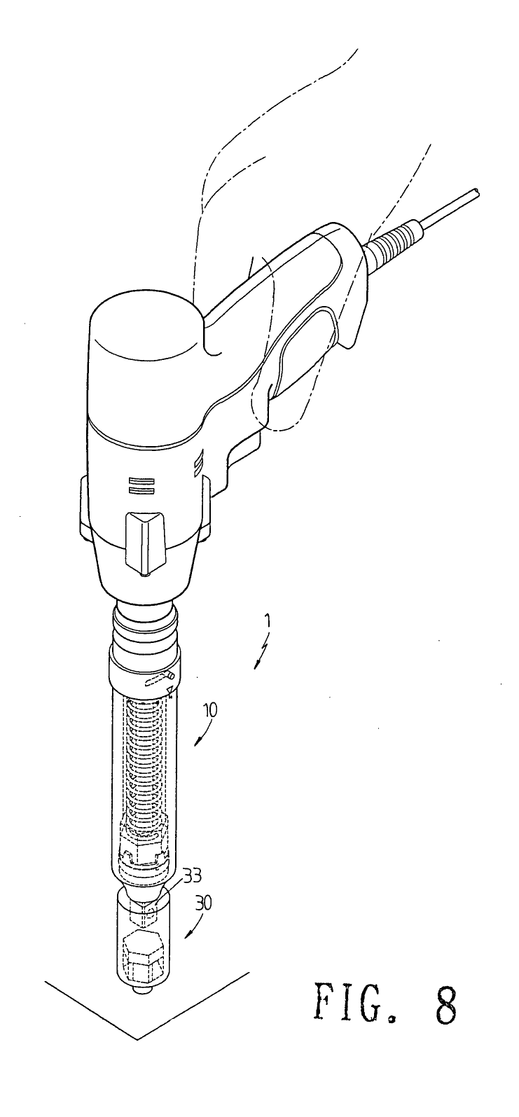

Moreover, in this embodiment, the engaging end 33 of the head 30 is a protruded polygonal structure so that the engaging end 33 can be engaged with a socket of various sizes, as shown in FIG. 8. The present invention can be used with dynamic tools and socket of various sizes so as to extend the length thereof and the setting of the tension value for preventing an overlarge twisting is adjustable.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A socket connection device of adjustable tension value for preventing an overlarge twisting force, comprising:
a seat having an approximate round cylinder; the seat having a receiving space which penetrates through an upper and a lower end of the seat; one end of the seat being an engaging portion; another end of the seat being a hole section; the control section including a base, an adjusting block, an axial rod, an elastic unit and a buckle block; the base serving for positioning the axial rod; the axial rod of the control section for installing the adjusting block, the elastic unit and the buckle block; two ends of the elastic unit resisting against the adjusting block and the buckle block; the buckle block being received in the hole section of the receiving space; an outer side of the buckle block being corresponding to an inner side of the hole section so that the buckle block will not rotate with respect to the receiving space;
a head being formed as a long rod; one end of the head being a buckling end having a shape corresponding to that of the buckle block; an outer periphery of the head near the buckling end being formed with an annular groove; and another end of the head opposite to the buckling end being an engaging end.

2. The socket connection device of adjustable tension value for preventing an overlarge twisting force as claimed in claim 1, further comprising: a connecting groove formed at an outer side of the seat; the connecting groove being communicated to the receiving space; the connecting groove having a cambered shape; an adjusting ring enclosing an outer side of the seat; a pin having one end fixed to an inner side of the adjusting ring; the pin passes through the connecting groove and then to be fixed to the adjusting block; thus when the adjusting ring is rotated, the adjusting block will rotate therewith.

3. The socket connection device of adjustable tension value for preventing an overlarge twisting force as claimed in claim 1, wherein the engaging end is a protruded polygonal block or a recessed groove.

4. The socket connection device of adjustable tension value for preventing an overlarge twisting force as claimed in claim 1, wherein the buckle block has a cruciform recess.

5. The socket connection device of adjustable tension value for preventing an overlarge twisting force as claimed in claim 1, wherein the receiving space has a polygonal hole section and the buckle block has a polygonal shape.

6. The socket connection device of adjustable tension value for preventing an overlarge twisting force as claimed in claim 1, wherein an opening of the polygonal hole section has an engaging groove; a through hole is formed in the annular groove for receiving an elastic body; two C shape rings are engaged in the annular groove and also in the engaging groove of the seat so as to rotatably engage the head to the seat.

7. The socket connection device of adjustable tension value for preventing an overlarge twisting force as claimed in claim 1, wherein the inner wall of the recessed area is inclined.

8. The socket connection device of adjustable tension value for preventing an overlarge twisting force as claimed in claim 1, wherein an upper side of the recessed area has a smaller area and a lower side of the recessed area has a larger area.

9. The socket connection device of adjustable tension value for preventing an overlarge twisting force as claimed in claim 1, wherein one side of the receiving space having a key groove; and the adjusting block having a key which is received in the key groove of the receiving space so as to position the adjusting block without rotation.
